(19) United States
(12) Patent Application Publication
(10) Pub. No.: US 2002/0022114 A1
(43) Pub. Date: Feb. 21, 2002

(54) Leak-proof intermittent ultrasonic bonds

(76) Inventors: Daniel J. Sorensen, Neenah, WI (US); Robert Lee Popp, Hortonville, WI (US)

Correspondence Address: Pauley Petersen Kinne & Fejer, 2800 W. Higgins Road, Suite 365, Hoffman Estates, IL, 60195, US

(21) Appl. No.: 09/849,594

(22) Filed: May 4, 2001

Related U.S. Application Data
(60) Provisional application No. 60/209,393, filed on Jun. 1, 2000.

(51) Int. Cl. B32B 3/00; B32B 31/16

(52) U.S. Cl. 428/190; 156/73.4

(57) ABSTRACT

A strong, leak-proof seal includes a number of intermittent ultrasonic bonds spaced closely together. At least two layers of material, such as nonwoven webs laminated to a liquid-impermeable film, can be held together by these bond points. The bond points can be arranged in a pattern, such that material that is displaced during the bonding process blocks the passage of any fluid between the bond points.

### FIELD OF THE INVENTION

This invention relates to intermittent ultrasonic bonds that create a leak-proof seal.

### BACKGROUND OF THE INVENTION

Absorbent garments, including disposable diapers and training pants, and other personal care products require leak-proof seals in their assembly to ensure proper containment of bodily wastes, for example. Such leak-proof seals are typically accomplished through a continuous, or solid, bond pattern. This continuous pattern is usually formed by hot melt adhesives, thermal bonds or ultrasonic bonds.

Ultrasonic bond patterns can be intermittent points, applied in a pattern, that create a thermal bond between two or more layers of material. The bonds are normally stronger when a pattern of individual points is used rather than a continuous, or solid, bond. However, because intermittent bond points are spaced apart from one another, fluids can pass between the bond points and, therefore, the intermittent bonds are typically not leak-proof, or moisture proof.

There is a need or desire for a strong, leak-proof seal that can be used in the assembly of absorbent garments and other personal care products.

### SUMMARY OF THE INVENTION

The present invention is directed to intermittent ultrasonic bonds that create a strong, leak-proof seal. These bonds are particularly suitable for use in the assembly of absorbent garments and personal care products, including disposable diapers, training pants, feminine hygiene products, adult incontinence products, and medical garments. A strong, leak-proof seal is especially desirable for attaching containment flaps to garments, and for bonding composite structures.

The leak-proof, or moisture-proof, seal is created when at least two layers of material are ultrasonically bonded with numerous point bonds that are spaced sufficiently close together to create a seal between the bonds. When ultrasonic bonds are used to form a bond, part of the substrate material being bonded is displaced outside of the actual bond point. In this invention, the displaced materials either contact each other, thereby blocking any passage of fluid between the bond points, or are close enough together to create a sufficiently tortuous path to block any passage of fluid between the bond points. Furthermore, the strength of the bond is optimized through the use of point bonds, versus a solid bond.

With the foregoing in mind, it is a feature and advantage of the invention to provide a strong, leak-proof seal.

It is also a feature and advantage of the invention to provide a bonding process for bonding together at least two layers of material resulting in a strong, leak-proof seal.

These and other features and advantages will become further apparent from the following detailed description of the presently preferred embodiments, read in conjunction with the drawings.

### BRIEF DESCRIPTION OF THE DRAWINGS

FIG. 1 illustrates an enlarged, partial plan view of one type of point bond pattern bonding two sheets of material together in accordance with the present invention; and

FIG. 2 illustrates an enlarged sectional view of intermittent ultrasonic bond points bonding two sheets of material together, taken along line 2-2 of FIG. 1.

### DEFINITIONS

Within the context of this specification, each term or phrase below will include the following meaning or meanings.

“Bond point” refers to a discrete point where ultrasonic bonding has occurred.

“Bonded” refers to the joining, adhering, connecting, attaching, or the like, of two elements. Two elements will be considered to be bonded together when they are bonded directly to one another or indirectly to one another, such as when each is directly bonded to intermediate elements.

“Breathable” describes materials that typically block the passage of particulate matter, water and other liquids while allowing water vapor and air to pass through the material.

“Disposable” refers to articles which are designed to be discarded after a limited use rather than being laundered or otherwise restored for reuse.

“Elastic,” “elasticized” and “elasticity” mean that property of a material or composite by virtue of which it tends to recover its original size and shape after removal of a force causing a deformation.

“Film” refers to a thermoplastic film made using a film extrusion and/or foaming process, such as a cast film or blown film extrusion process. The term includes apertured films, slit films, and other porous films which constitute liquid transfer films, as well as films which do not transfer liquid.

“Layer” when used in the singular can have the dual meaning of a single element or a plurality of elements.

“Liquid impermeable,” when used in describing a layer or multi-layer laminate, means that a liquid, such as urine, will not pass completely through the layer or laminate, under ordinary use conditions, in a direction generally perpendicular to the plane of the layer or laminate at the point of liquid contact. Liquid, or urine, may spread or be transported parallel to the plane of the liquid impermeable layer or laminate, so long as it does not pass through the layer or laminate.

“Liquid permeable material” or “liquid water-permeable material” refers to a material present in one or more layers, such as a film, nonwoven fabric, or open-celled foam, which is porous, and which is water permeable due to the flow of water and other aqueous liquids through the pores. The pores in the film or foam, or spaces between fibers or filaments in a nonwoven web, are large enough and frequent enough to permit leakage and flow of liquid water through the material.

“Medical garment” refers to medical (i.e., protective and/or surgical) gowns, caps, gloves, drapes, face masks, and the like.

“Meltblown fiber” means fibers formed by extruding a molten thermoplastic material through a plurality of fine, usually circular, die capillaries as molten threads or filaments into converging high velocity heated gas (e.g., air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed for example, in U.S. Pat. No. 3,849,241 to Butin et al. Meltblown fibers are microfibers which may be continuous or discontinuous, are generally smaller than about 0.6 denier, and are generally self bonding when deposited onto a collecting surface. Meltblown fibers used in the present invention are preferably substantially continuous in length.

“Nonwoven” and “nonwoven web” refer to a material or a web of material having a structure of individual fibers or filaments which are interlaid, but not in an identifiable manner as in a knitted fabric. The terms “fiber” and “filament” are used herein interchangeably. Nonwoven fabrics or webs have been formed from many processes such as, for example, meltblowing processes, spunbonding processes, air laying processes, and bonded carded web processes. The term also includes films that have been perforated or otherwise treated to allow air to pass through.

“Offset” refers to an angle measured from a point on a line to another point not on the line.

“Point bond” refers to a type of bond that is discontinuous, as opposed to a continuous, or solid, bond.

“Polymers” include, but are not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and atactic symmetries.

“Spunbonded fiber” refers to small diameter fibers which are formed by extruding molten thermoplastic material as filaments from a plurality of fine capillaries of a spinnerette having a circular or other configuration, with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartmann, U.S. Pat. No. 3,502,538 to Petersen, and U.S. Pat. No. 3,542,615 to Dobo et al., each of which is incorporated herein in its entirety by reference. Spunbond fibers are quenched and generally not tacky when they are deposited onto a collecting surface. Spunbond fibers are generally continuous and often have average deniers larger than about 0.3, more particularly, between about 0.6 and 10.

“Stretchable” means that a material can be stretched, without breaking, to at least 150% of its initial (unstretched) length in at least one direction, suitably to at least 200% of its initial length, desirably to at least 250% of its initial length.

“Thermoplastic” describes a material that softens when exposed to heat and which substantially returns to a nonsoftened condition when cooled to room temperature.

These terms may be defined with additional language in the remaining portions of the specification.

### DETAILED DESCRIPTION OF THE PRESENTLY PREFERRED EMBODIMENTS

The principles of this invention can be applied to a wide variety of garments and personal care products, including disposable garments having at least two layers 12, 14 of material bonded together wherein the resulting seam is exposed to moisture during routine use. Examples include diapers, training pants, certain feminine hygiene products, adult incontinence products, other personal care or medical garments, and the like. More particularly, this invention can be applied to the attachment of containment flaps to such garments and to the bonding of composite structures.

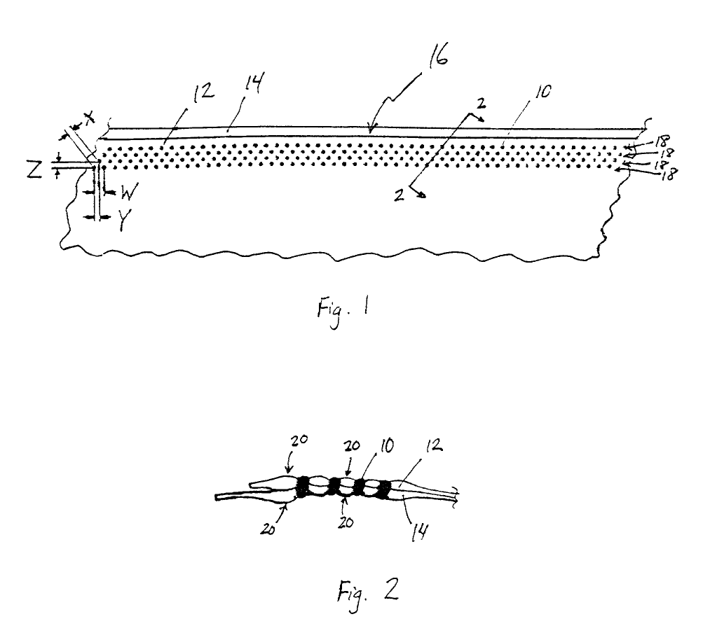

Referring to FIG. 1, a pattern of intermittent ultrasonic bond points 10 is shown applied to two layers 12, 14 of material, wherein a first layer 12 is positioned on top of a second layer 14 and the second layer 14 extends beyond the first layer 12. The first layer 12 and the second layer 14 must at least partially overlap. The bond points 10 bond the two layers 12, 14 together, resulting in a strong, leak-proof seal 16. The seal 16 is strong due to the many bond points 10, and small distances between the bond points 10 prevent moisture from penetrating through the seal 16. As shown in FIG. 1, one embodiment of the invention includes multiple parallel rows 18 of bond points 10, wherein the bond points 10 in adjacent rows 18 are offset from one another, anywhere from about 0 degrees to about 89 degrees, alternatively from about 15 degrees to about 75 degrees, as yet another alternative, from about 30 degrees to about 60 degrees. This invention requires at least one row 18 of bond points 10, or at least two rows 18 of bond points 10, alternatively at least three rows 18, or, as another alternative, at least four rows 18.

Each bond point 10 is suitably round, or any other suitable shape such as oblong, figure-eight, or rectangular, for example. Each bond point 10 suitably has a diameter of between about 0.005 inch (0.013 cm) and about 0.25 inch (0.64 cm), alternatively between about 0.010 inch (0.025 cm) and about 0.175 inch (0.44 cm), or, as another alternative, between about 0.015 inch (0.038 cm) and about 0.15 inch (0.38 cm).

Similarly, each bond point 10 is a distance of between about 0.001 inch (0.0025 cm) and about 0.20 inch (0.51 cm) away from at least one other bond point 10 in either a machine direction or a cross direction, or any direction therebetween. Alternatively, each bond point 10 is within about 0.0025 inch (0.0064 cm) to about 0.175 inch (0.44 cm) of at least one other bond point 10. As another alternative, each bond point 10 is within about 0.005 inch (0.013 cm) to about 0.15 inch (0.38 cm) of at least one other bond point 10.

Examples of various measurable distances between the bond points 10 are shown in FIG. 1. More specifically, a distance W is a linear distance between two adjacent bond points 10 in a row 18, a distance X is a linear distance between two bond points 10 diagonal from one another, a distance Y is a horizontal distance between the two diagonal bond points 10 wherein the two points 10 are vertically offset, and a distance Z is a vertical distance between two bond points 10 wherein the two bond points 10 are horizontally offset. The pattern width is the total vertical 10 distance between the top row 18 and the bottom row 18 of bond points 10.

When ultrasonic bond points 10 are applied to a substrate 12, part of the substrate material being bonded is displaced outside of the actual bond point 10, as shown in FIG. 2. In this invention, the displaced materials 20 of each layer 12, 14 either contact each other, or are close enough together to create a sufficiently tortuous path to block any passage of fluid between the bond points 10. Due to the heat generated by the ultrasonic bonding process at the point bonds 10, the displaced materials 20 between the point bonds 10 are in a molten form when the displacement occurs. The molten displaced materials 20 bond together when in contact with one another due to the heat generated and pressure exerted during the ultrasonic bonding process, thereby forming a light bond between the displaced materials 20 of adjacent layers 12, 14 and blocking any passage of fluid between the bond points 10 and the displaced materials 20 between the layers 12, 14. Furthermore, the strength of the seal 16 is optimized through the use of point bonds, versus a solid bond.

The ultrasonic bonding process can be carried out by a variety of methods (not shown), including using an ultrasonic stationary horn or an ultrasonic rotary horn or different frequency horns. In the stationary method, a stationary anvil is located below the ultrasonic horn, or wave guide. The materials 12, 14 are coupled to the horn, or wave guide, such that the materials 12, 14 are between the horn and the anvil. The horn vibrates at a specific rate, e.g. 20,000 cycles/sec, with an amplitude of roughly 0.0005 inch (0.0013 cm) to about 0.0035 inch (0.0089 cm) emitting ultrasonic energy through friction and thereby bonding the materials 12, 14 together.

In the rotary method, the materials 12, 14 are placed between a rotating disk and a rotating anvil, preferably a circular anvil with a pattern on a surface contacting the materials 12, 14. The rotating disk vibrates, expanding and contracting around its circumference by up to about 0.0035 inch (0.0089 cm). As in the stationary method, friction causes the emission of ultrasonic energy, thereby bonding the materials 12, 14 together. Furthermore, the pattern on the anvil forms a bonding pattern that is transferred to the materials 12, 14.

Suitable substrate materials for the at least two layers 12, 14 of material in the present invention include liquid-impermeable materials, including nonwoven web laminates made from a wide selection of materials. Various nonwoven fabrics can be laminated to a film or other liquid-impermeable layer to be used as the substrate. For example, the substrate can be composed of a meltblown or spunbonded web of polyolefin fibers, laminated to a liquid impermeable layer. The substrate can also be a bonded-carded web composed of natural and/or synthetic fibers, laminated to a liquid impermeable layer. While the layers 12, 14 are suitably liquid-impermeable, the layers 12, 14 may be breathable as well.

The substrate is preferably a liquid impermeable material or is laminated to a liquid impermeable material. One example of a suitable liquid impermeable material is a thin plastic film, although other flexible liquid impermeable materials may also be used. A suitable liquid impermeable film for use as a substrate is a polyolefin film, for instance, a 0.2 millimeter polyethylene film commercially available from Huntsman Packaging of Newport News, Va. U.S.A.

The substrate can also include an elastic material, for example, as described in terms of side panels of an absorbent garment in U.S. Pat. No. 4,940,464, issued Jul. 10, 1990, to Van Gompel et al., which is incorporated herein by reference. Furthermore, the elastic material can be used as virtually any part of an absorbent garment or personal care product and can include a stretch-thermal laminate (STL), a neck-bonded laminated (NBL), a reversibly necked laminate, or a stretch-bonded laminate (SBL) material. Methods of making such materials are well known to those skilled in the art and described in U.S. Pat. No. 4,663,220 issued May 5, 1987 to Wisneski et al.; U.S. Pat. No. 5,226,992 issued Jul. 13, 1993 to Morman; and European Patent Application No. EP 0 217 032 published on Apr. 8, 1987 in the names of Taylor et al.; all of which are incorporated herein by reference. Alternatively, these elastic materials may include other woven or nonwoven materials, or stretchable but inelastic materials.

As mentioned, the present invention can be applied to diapers, training pants, certain feminine hygiene products, adult incontinence products, other personal care or medical garments, and the like.

### EXAMPLE

Nine different bond patterns were produced and evaluated for their ability to produce a moisture impervious seal. For each sample, two 6-inch square layers of material were bonded together using a 20 kHz ultrasonic rotary horn along the edges of the perimeters of the layers, approximately 0.1 inch from the edges. The material was a laminate of 0.6 osy polypropylene spunbond adhesively laminated to 0.6 mil polypropylene film, with the film sides of each of the two layers facing one another. The bond points in each of the patterns were round, each having a diameter of 0.045 inch (0.1 1 cm). The bond pattern sections along each 6-inch edge were arranged in four rows of bond points. The linear distance between adjacent bond points in a row, i.e., the machine direction spacing, ranged from 0.05 inch (0.13 cm) to 0.11 inch (0.28 cm), with actual values listed in Table 1. The vertical distance between horizontally offset bond points, i.e., the cross direction spacing, ranged from 0.10 (0.25 cm) to 0.30 (0.76 cm), with actual values listed in Table 1. The pattern width of the bond point sections, i.e., the distance between the first row of bond points and the fourth row of bond points, ranged from 0.210 inch to 0.270 inch, with actual values listed in Table 1. The bond points in adjacent rows were approximately 35 to 58 degrees offset from one another, with actual values listed in Table 1.

Before sealing the complete perimeter of the two layers, the resulting container was filled with 250 milliliters of blue-dyed saline solution. The bonded container was then set on a horizontal surface for 14 days and was observed for leakage. As can be seen in Table 1, the only tested bond pattern section that leaked was the section having machine direction spacing of 0.11 inch, cross direction spacing of 0.010 inch, and a pattern width of 0.210 inch.

TABLE 1
Bond Point Sections Tested for Leakage

| | Machine | Cross | | | |
|---|---|---|---|---|---|
| | Direction | Direction | | | |
| | Space | Space | | | |
| | Between | Between | Pattern | Bond | |
| | Bond Points | Bond Points | Width | Angle | Moisture |
| Sample | (inches) | (inches) | (inches) | (degrees) | Impervious |
| 1 | 0.05 | 0.010 | 0.210 | 35 | Yes |
| 2 | 0.05 | 0.020 | 0.240 | 40 | Yes |
| 3 | 0.05 | 0.030 | 0.270 | 44 | Yes |
| 4 | 0.08 | 0.010 | 0.210 | 41 | Yes |
| 5 | 0.08 | 0.020 | 0.240 | 46 | Yes |
| 6 | 0.08 | 0.030 | 0.270 | 50 | Yes |
| 7 | 0.11 | 0.010 | 0.210 | 49 | No |
| 8 | 0.11 | 0.020 | 0.240 | 54 | Yes |
| 9 | 0.11 | 0.030 | 0.270 | 58 | Yes |

The sample with the longest machine direction spacing (0.011 inch) and the shortest cross direction spacing (0.010 inch) was the only sample that leaked. The short cross direction spacing results in a small pattern width. The small pattern width translates to a short path through which fluid must travel to pass through the point bond section. It is believed that a point bond section having a combination of relatively long machine direction spacing and a relatively small pattern width results in a greater likelihood of leakage than a point bond section having relatively short machine direction spacing and/or a relatively large pattern width.

While the embodiments of the invention described herein are presently preferred, various modifications and improvements can be made without departing from the spirit and scope of the invention. The scope of the invention is indicated in the appended claims, and all changes that fall within the meaning and range of equivalents are intended to be embraced therein.

What is claimed:

1. A leak-proof seal, comprising:
at least two layers of liquid-impermeable material at least partially positioned in overlapping relationship;
a plurality of ultrasonic bond points bonding together the at least two layers of liquid-impermeable material;
wherein the bond points are aligned in at least two parallel rows and the bond points in adjacent rows are offset from one another.

2. The leak-proof seal of claim 1 wherein adjacent bond points are at a distance of between about 0.001 inch and about 0.20 inch from one another.

3. The leak-proof seal of claim 1 wherein adjacent bond points are at a distance of between about 0.0025 inch and about 0.175 inch from one another.

4. The leak-proof seal of claim 1 wherein adjacent bond points are at a distance of between about 0.005 inch and about 0.15 inch from one another.

5. The leak-proof seal of claim 1 wherein each bond point has a diameter of between about 0.005 inch and about 0.25 inch.

6. The leak-proof seal of claim 1 wherein each bond point has a diameter of between about 0.010 inch and about 0.175 inch.

7. The leak-proof seal of claim 1 wherein each bond point has a diameter of between about 0.015 inch and about 0.15 inch.

8. The leak-proof seal of claim 1 wherein the bond points in adjacent rows are offset from one another by about 0 degrees to about 89 degrees.

9. The leak-proof seal of claim 1 wherein the bond points in adjacent rows are offset from one another by about 15 degrees to about 75 degrees.

10. The leak-proof seal of claim 1 wherein the bond points in adjacent rows are offset from one another by about 30 degrees to about 60 degrees.

11. The leak-proof seal of claim 1 further comprising at least three parallel rows of bond points.

12. The leak-proof seal of claim 1 further comprising at least four parallel rows of bond points.

13. The leak-proof seal of claim 1 wherein at least one of the layers of liquid-impermeable material is breathable.

14. A combination of a first liquid-impermeable, nonwoven laminate bonded to a second liquid-impermeable material, comprising:
a plurality of ultrasonic bond points joining the first liquid-impermeable, nonwoven laminate to the second liquid-impermeable material;
wherein the bond points are aligned in a pattern such that each bond point is within about 0.001 inch to about 0.20 inch of at least one other bond point.

15. The combination of claim 14 wherein each bond point is within about 0.0025 inch to about 0.175 inch of at least one other bond point.

16. The combination of claim 14 wherein each bond point is within about 0.005 inch and about 0.15 inch of at least one other bond point.

17. The combination of claim 14 wherein the bond points are aligned in at least two parallel rows and the bond points in adjacent rows are offset from one another.

18. The combination of claim 14 wherein the first liquid-impermeable, nonwoven laminate comprises a liquid-impermeable film.

19. The combination of claim 14, wherein the first liquid-impermeable, nonwoven laminate is breathable.

20. The combination of claim 14 wherein the second liquid-impermeable material comprises a nonwoven material laminated to a liquid-impermeable film.

21. The combination of claim 14, wherein the second liquid-impermeable material is breathable.

22. An absorbent garment comprising the combination of claim 14.

23. A diaper comprising the combination of claim 14.

24. A training pant comprising the combination of claim 14.

25. A feminine hygiene article comprising the combination of claim 14.

26. An absorbent underpant comprising the combination of claim 14.

27. A bonding process for bonding together two layers of liquid-impermeable material, comprising the steps of:
ultrasonically bonding the two layers together with discrete bond points; and
displacing portions of each layer of material, wherein each of the displaced portions is in contact with at least one other displaced portion.

28. The bonding process of claim 27 wherein at least one of the layers of liquid-impermeable material comprises a nonwoven web.

29. The bonding process of claim 27 wherein at least one of the layers of liquid-impermeable material is breathable.

30. The bonding process of claim 27 wherein the bond points are aligned in a pattern such that each bond point is within about 0.001 inch to about 0.20 inch of at least one other bond point.

31. The bonding process of claim 27 wherein the bond points are aligned in a pattern such that each bond point is within about 0.0025 inch to about 0.175 inch of at least one other bond point.

32. The bonding process of claim 27 wherein the bond points are aligned in a pattern such that each bond point is within about 0.005 inch and about 0.15 inch of at least one other bond point.

33. The bonding process of claim 27 wherein the bond points are aligned in at least two parallel rows and the bond points in adjacent rows are offset from one another.
